(19) United States
(12) Patent Application Publication
(10) Pub. No.: US 2011/0285981 A1
(43) Pub. Date: Nov. 24, 2011

(54) Sensor Element and System Comprising Wide Field-of-View 3-D Imaging LIDAR

(75) Inventors: James Justice, Newport Beach, CA (US); Medhat Azzazy, Laguna Niguel, CA (US); David Ludwig, Irvine, CA (US)

(73) Assignee: Irvine Sensors Corporation, Costa Mesa, CA (US)

(21) Appl. No.: 13/108,172

(22) Filed: May 16, 2011

Related U.S. Application Data
(60) Provisional application No. 61/395,712, filed on May 18, 2010.

(51) Int. Cl. G01C 3/08

(52) U.S. Cl. 356/4.01

(57) ABSTRACT

A LIDAR sensor element and system for wide field-of-view applications such as autonomous UAS landing site selection is disclosed. The sensor element and system have an imaging source such as a SWIR laser for imaging a field of regard or target with a beam having a predefined wavelength. The beam is scanned over the field of regard or target with a beam steering device such as Risley prism. The reflected beam is captured by the system by receiving optics which may comprise a Risley prism for receiving and imaging the reflected beam upon a photodetector array such as a focal plane array. The focal plane array may be bonded to and a part of a three-dimensional stack of integrated circuits, a plurality of which may comprise one or more read out integrated circuits.

### CROSS-REFERENCE TO RELATED APPLICATIONS

This application claims the benefit of U.S. Provisional Patent Application No. 61/395,712, filed on May 18, 2010 entitled “Autonomous Landing at Unprepared Sites for a Cargo Unmanned Air System” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of LIDAR imaging systems. More specifically, the invention relates to a UAS autonomous landing sensor system comprising a wide field-of-view 3-D imaging LIDAR.

2. Description of the Related Art

Unmanned Air or Aerial Systems (UAS) have revolutionized certain aspects of military operations. Without the need for an onboard flight crew, UAS are able to maintain position for longer periods of time and permit rotations of crews more frequently for increased vigilance. This success has opened up the possibility of developing UAS that transport cargo to forward operating bases and outposts that may be hundreds of kilometers from the supply base. In contemporary settings, supply lines to these forward operating bases are prime targets for enemy attack and rough (e.g., mountainous terrain) affords an enemy ample opportunity to make these attacks highly successful. Taking advantage of unmanned aerial resupply using UAS reduces the risk of the flight, making it an attractive way to reduce the overall mission costs if an attack is successful.

Delivering war materials to fighting forces in a timely manner is a problem that exists at all levels of conflict. Delivery solutions are particularly critical for sea-to-land force projection. Cost-effective solutions that enhance effectiveness while achieving cost reductions are needed for increased security.

A particularly attractive approach to simultaneously reducing costs and increasing effectiveness is having the capability for material delivery to needed sites by using UAS. Further effectiveness in supporting the war fighter is achieved if autonomous landing procedures accomplish secure landings on unprepared ground.

Such UAS capabilities can be achieved if sensing systems provide accurate three-dimensional (3-D) scene images with sufficient update rates at sufficient ranges to allow processing algorithms to search for, characterize, and select landing sites and then provide navigation system inputs for landing execution. A brief review of prior art UAS cargo operations reveals at least two deficiencies that presently limit the ability of cargo UAS to complete the needed phases of a cargo transport mission.

Current UAS are capable of autonomously handling launch and flight and landing on a properly prepared site. These systems also provide operator interfaces if manual landing is needed or desired. At forward operating positions though, there typically are no properly prepared landing sites. In addition, while current UAS can be landed by handing off the landing operation to a skilled operator with line-of-sight (LOS) to the aircraft, there may not be an operator available at the remote site.

For a UAS to autonomously land at an unprepared site, the UAS must first search for a suitable landing site in a wide variety of environmental conditions. Once a landing site has been selected, the UAS must construct a precise flight plan to the landing site. Finally, the UAS must carefully execute the landing plan and accommodate the fact GPS or other navigation aids available at higher altitudes degrade as altitude decreases, in order to avoid striking any obstacles that are detected.

By solving the problem of autonomously landing a cargo UAS, the sensor system of the invention assists in enabling UAS cargo transport to nearly any location at any time, without in-flight risk to military personnel by minimizing the need for special support equipment in any landing zone, prepared or not. This flexibility greatly increases the speed with which UAS launch-capable operating bases can be established.

For a UAS equipped with a flight control system for general path and waypoint following, an autonomous landing system must add support for at least four specific tasks unique to landing: 1) identify a landing site or zone, 2) determine a safe path to the landing zone, 3) send the calculated plan to the flight control system, and, 4) track the UAS position relative to the landing zone to aid the flight control system in landing precisely at the landing zone.

For an unprepared landing site, an autonomous landing system must first determine the best location at which to land. Field personnel may have communicated a general area, e.g., “land in the valley around these coordinates”, but may not have fully considered the landing site constraints for the particular cargo UAS that is assigned the mission.

The invention takes advantage of 3-D sensing and imaging to scan the terrain in the proximately of the landing zone and uses perception to analyze the data for preferred or predetermined landing site attributes. If a suitable landing site is not identified from an initial single scan, the system is provided with an autonomous flight planner to move the aircraft to explore other potential landing locations.

With the generated flight plan, the UAS cooperates with existing UAS flight controllers to execute the plan as most UAS include their own flight controllers which are optimally designed for, and tightly coupled to, the particular UAS.

Three components of autonomous UAS operation are addressed by the invention:

1. Sensors to scan the terrain to measure terrain shape and features,

2. Terrain perception to identify suitable landing zones,

3. Flight planning data to move the aircraft if perception has not reported a suitable landing site.

Once a landing site has been selected, the autonomous landing system must plan a flight path to that site. This utilizes a single component: a flight path planner. That planner also handles sending the plan to the flight control system.

The next task is to assist the flight control system by tracking the UAV pose (position, attitude, and heading) relative to the landing site. If good GPS is available throughout the landing procedure, this step is not needed. However, in many landing situations GPS will degrade or drop out entirely due to terrain occlusions and multi-path GPS signal effects near the ground.

Finally, landing zone tracking may be performed to measure UAV pose relative to the landing zone.

What is needed is a UAV sensors system that addresses the above concerns and overcomes the deficiencies in the prior art and that will permit autonomous landing of a UAS or UAV by providing high resolution 3-D landing site data for use by the UAS in its autonomous operation.

### BRIEF SUMMARY OF THE INVENTION

A LIDAR sensor element and system for wide field-of-view applications such as autonomous UAS landing site selection is disclosed. The sensor element and system have an imaging source such as a laser for imaging a field of regard or target location with a beam having a predefined wavelength.

The beam is scanned over the field of regard with a beam steering device such as Risley prism. The reflected beam is captured by receiving optics which may comprise a Risley prism for receiving and imaging the reflected beam upon a photodetector array such as a focal plane array.

The focal plane array may be bonded to and a part of a three-dimensional stack of integrated circuits, a plurality of which may comprise one or more read out integrated circuits.

In a first aspect of the invention, the sensor element comprises an imaging source such as a SWIR laser having a predetermined wavelength of the electromagnetic spectrum. The first aspect further comprises imaging source beam steering means comprising a plurality of counter-rotating optical wedges or prisms for imaging a target with the imaging source such as a Risley prism assembly. The first aspect comprises a photodetector array responsive to the predetermined wavelength of the imaging source and optical receiving beam steering means comprising a plurality of counter-rotating optical wedges or prisms such as a Risley prism assembly for receiving, transmitting and scanning the reflected imaging source energy from the target to and across the photodetector array.

In a second aspect of the invention, the photodetector array of the sensor element comprises a three-dimensional electronic module comprising a stack of integrated circuit chips comprising at least one read out integrated circuit.

In a third aspect of the invention, the predetermined wavelength of the imaging source for the sensor element is about 1.54 microns.

In a fourth aspect of the invention, the photodetector array of the sensor element comprises an InGaAs focal plane array responsive to the 1.54 micron region of the electromagnetic spectrum.

In a fifth aspect of the invention, a sensor system is disclosed comprising a plurality of sensor elements wherein each of the sensor elements comprises an imaging source having a predetermined wavelength of the electromagnetic spectrum. The fifth aspect may comprise imaging source scanning means comprising a plurality of counter-rotating optical wedges or prisms for imaging a target with the imaging source, a photodetector array responsive to the predetermined wavelength of the imaging source, optical receiving means comprising a plurality of counter-rotating optical wedges or prisms for receiving and transmitting reflected imaging source energy from the target to the photodetector array.

In a sixth aspect of the invention, the photodetector array of the sensor system comprises a three-dimensional electronic module comprising a stack of integrated circuit chips comprising at least one read out integrated circuit.

In a seventh aspect of the invention, the predetermined wavelength of the imaging source of the sensor system is about 1.54 microns.

In an eighth aspect of the invention, the photodetector array of the sensor system comprises an InGaAs focal plane array responsive to the 1.54 micron region of the electromagnetic spectrum.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 illustrates an autonomous UAS on approach as it acquires and analyzes potential landing site data and then landing at the selected site.

FIG. 2 is a flow chart of the operations flow and top level system architecture of the invention, illustrating the autonomous landing site selection steps in the operation.

FIG. 3 shows a graph illustrating special resolution of the sensor system with respect to range to ground.

FIG. 4 depicts a general concept of operation of the sensor system of the invention.

FIG. 5 illustrates a block diagram of a preferred embodiment of the sensor system of the invention.

FIG. 6 is a table showing a set of input parameters for a preferred embodiment of the invention.

FIG. 7 is a graph showing estimated system performance using a verified model.

FIG. 8 is a diagram of an alternative embodiment of a sensor system of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures wherein like numerals define like elements among the several views, a UAS autonomous landing sensor system comprising a wide field-of-view 3-D imaging LIDAR is disclosed.

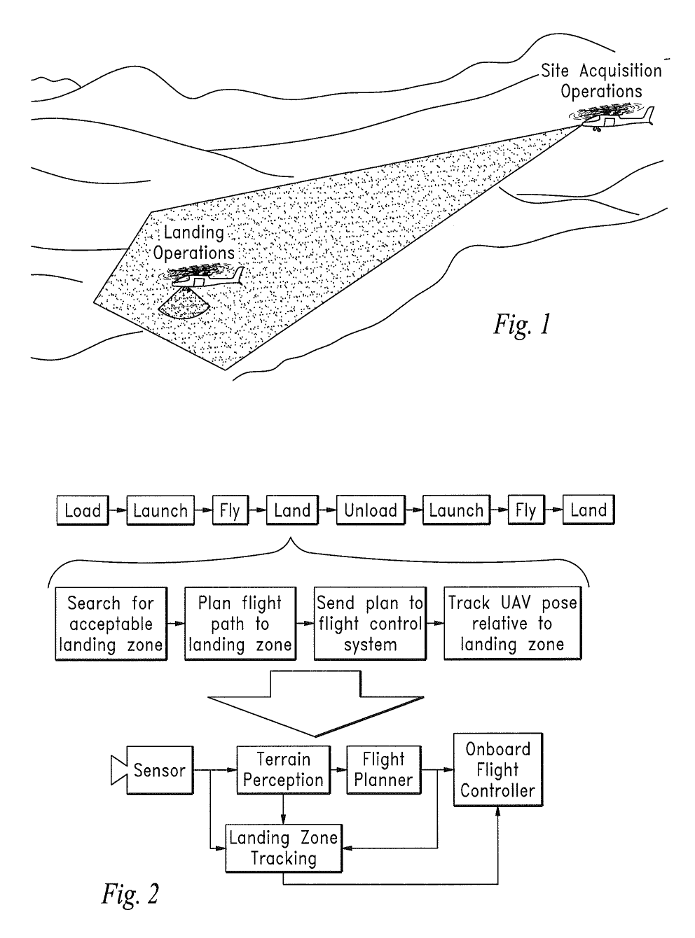

The UAS autonomous landing approach commonly used in UAS applications is generally illustrated in FIG. 1 showing the UAS surveying potential landing sites using the sensor system of the invention and engaging in an autonomous landing operation at the selected site.

The invention may comprise state-of-the-art, eye-safe, high pulse rate fiber lasers to achieve rapid, accurate three-dimensional surveillance of potential UAS landing sites.

Processing algorithms running in suitable electronic circuitry the process the received three-dimensional voxel data from the sensor system to characterize the scenes, select a preferred landing location, and enable the navigation system of the UAS to achieve accurate landing operations under a broad range of operating conditions.

In accordance therewith, the invention provides an autonomous cargo landing sensor system for use in unprepared areas that incorporates 3-D LIDAR technology, providing timely and accurate data to algorithms for scene search, characterization, site selection and landing sequence control.

Combining the elements of a UAS autonomous operation results in an operations flow as illustrated in FIG. 2. FIG. 2 is a flow chart illustrating the autonomous landing site selection steps in a UAS “load-land-unload-land” cycle. FIG. 2 describes the operational steps of the autonomous first “land” operation in the cycle and further illustrates the role of the sensor system of the invention with respect to the overall UAS site selection process.

With respect to landing site “scene” phenomenology, the fundamental physical processes that contribute to the “as perceived” 3-D LIDAR images of the scenes being observed by a prior art UAS sensor system are an important consideration and can limit achievable performance of prior art systems.

Scene phenomenology issues begin with the bi-directional reflectance of individual scene elements. It is the differences found in scene element bi-directional reflectance that assist in enabling determination of scene content and identification/selection of candidate landing sites.

Variations in apparent brightness, spatial texture and spatial extent are key discriminators in such a system. Stored natural scene databases may be incorporated into the system of the invention to provide quantitative input to system performance.

Atmospheric propagation characteristics impose an additional set of considerations on system performance. Two-way transmission losses can fundamentally affect the resulting signal-to-noise ratios (S/N) that are achieved. Yet further, a wide variety of phenomena, both natural and man-made, may cause absorption or scattering of the transmitted laser pulse energy of the UAS LIDAR system.

Important among these effects is the molecular content of “clear” air which varies with location and seasons, rain/fog conditions, dust (brownout), and smoke (often present in active combat areas). For longer paths of observation, atmospheric turbulence effects may affect image resolution. The invention may utilize state-of-the-art phenomenology databases and models (e.g. MODTRAN, HiTRAN, etc.), as input to provide improved treatment of phenomenological processes in its design and simulation environments. Where significant uncertainties exist in phenomenology effects, parametric analysis of the effects of the uncertainties is preferably performed.

Existing autonomous landing systems comprise three general classes of algorithms: 1) terrain perception, 2) flight planning, and 3) landing zone tracking as are briefly discussed below.

1. Terrain Perception: An important UAS task is the identification of appropriate candidate landing zones without anything more than general guidance about where to look. The UAS is typically given a GPS-referenced waypoint for landing, but that point may be viewed as a general suggestion or hint as the terrain at that specific point may not be appropriate for landing for many reasons. For example, the terrain may be too steep, too rough, too near a cliff or wall, or under power lines or other low-hanging overhead obstructions that prevent flight down to the location.

The UAS LIDAR sensing provides a massive amount of information, but terrain perception must integrate and process it very quickly to assess landing zone fitness.

Prior efforts have developed significant capabilities in this area of computer perception suitable for UAS. Under the PerceptOR program funded by DARPA, scout helicopters equipped with LIDAR and camera sensors have been used to perceive terrain for use in unmanned off-road ground vehicle route-planning. Within this application, sensing and aircraft control algorithms were developed together to explore and find routes in a coordinated manner between air and ground vehicles. That program continued by collecting large-scale, high-resolution LIDAR imagery from manned over-flights of nearly a dozen test sites at military and civilian test areas around the country. Several unmanned vehicle programs have been improving terrain understanding and vehicle modeling through extensive field testing and by utilizing sophisticated vehicle model simulation package. Further, the program has developed road detection software that properly analyzes terrain and determines road boundaries using terrain classification, technology directly applicable to landing site identification.

Under these and other programs, perception libraries are available that analyze and determine attributes about the terrain. Determining slope, positive or negative obstacles, flatness (with or without slope), terrain surface type, terrain classification as well as the associated confidence of each of these features are all standard operations for perception software. Algorithms are available such as those developed by Applicant that utilize sensor data collected from ground vehicles or from the air and can be configured for dealing with sparse or irregular sampling of data.

The sensor system of invention may use data collected from an overhead aircraft LIDAR capable of producing approximately 40 points per square meter. Using this information, the invention processes the data, looking for slope, flatness and potential UAS obstacles. Assuming an exemplar search radius of 10 meters, software is provided to select and score potential landing sites within the LIDAR data.

The invention takes advantage of existing over-flight LIDAR data to feed real-world LIDAR data at variable density to the UAS.

2. Flight Planning: Another important task in autonomous UAS landing is flight planning. Given a feasible landing zone, the UAS must autonomously construct a path to the landing zone and down to the ground. This path must avoid all obstacles and meet the maneuvering constraints of the aircraft. In other types of planning applications, the environment may be completely unknown before the mission and the landing zone may be far away; factors that greatly increase the complexity of the planning task.

The National Robotics Engineering Center at Carnegie Mellon University or “NREC” has developed significant capabilities in path planning for both ground and air vehicles. NREC has developed tightly coupled UAV-UGV teams in which UAV flight paths were autonomously generated by a UGV attempting to traverse terrain. In one case, the planning task was to maintain a set altitude while moving laterally to fill in gaps beyond the UGV's own sensor range. This sophisticated planning system used the “Field D-Star” path planning navigation algorithm at its core. This algorithm is a powerful continuous-map extension of the common Aster graph planner. The path planning program was transformed into a graph-like search problem to find the optimal path and D-Star not only planned the initial path but replanned the path several times per second.

D-Star has led to a significant family of related planners well-suited to various types of motion planning. One variant is operating on the Mars rovers Spirit and Opportunity, helping to relieve earth-bound scientists from the monotony of precisely planning every aspect of motion control with a 7-minute communications delay.

One embodiment the system of the invention may comprise a path planning algorithm such as the 3-D D-Star, a variant that generates provably optimal plans through a cost field. D-Star not only uses obstacles to eliminate path options, but also can be set to create danger zones near obstacles that the planner automatically tries to avoid unless no other option exists.

3. Landing Zone Tracking: The third activity during landing is assisting the onboard flight control system in tracking the precise location of the desired landing zone, and especially the precise landing site. The general problem of pose estimation is well-known, with tightly coupled global positioning system/inertial navigation system (“GPS/INS”) solutions working well in a broad range of situations.

However, during landing, the GPS antenna gets much closer to the ground, increasing the likelihood of multi-path effects due to ground reflections. More importantly, if the UAS faces a landing in a valley or near tall buildings and terrain features, GPS may be blocked entirely. GPS alone, then, is insufficient. The INS may be enough to maintain awareness of position, but it is in a race: once GPS signal lock is lost, the INS begins double-integrating accelerometers in order to estimate position. The integration can quickly build up substantial position error, especially when flight dynamics are unpredictable—as is the case with the landing phase of flight.

Technology exists such as from NREC to mitigate this problem by registering live sensor data to a predefined reference map. In this application, the map is not provided externally: it is built up by a terrain perception module as that module searches for a landing zone. That process requires the module to build a model of the landing zone, which is made available as a reference to which the landing zone tracker measures UAS pose. Given a map of the area, the tracker then registers incoming data to the map. This technique has, for instance, been used to localize ground vehicles within an indoor factory, using images of the floor as reference.

The operation of the autonomous cargo landing system of the invention uses a highly sensitive, wide field-of-view 3-D Imaging LIDAR. A preferred embodiment uses an eye-safe LIDAR sensor system that can survey 1,800 deg² out to a range of >1 Km.

A high resolution 3-D map of the scene volume is produced 5 times a second. The search field, directed forward, is initially used to “survey and characterize” candidate landing zones. Upon selection of a landing zone, the wide field-of-view 3-D LIDAR is pointed continuously at this zone as the unmanned vehicle executes an approach and landing sequence. This processing is enabled by an algorithm architecture executed in real-time such as on a multi-FPGA-based processor for providing the navigation subsystem with timely and accurate inputs needed to effect the desired operations.

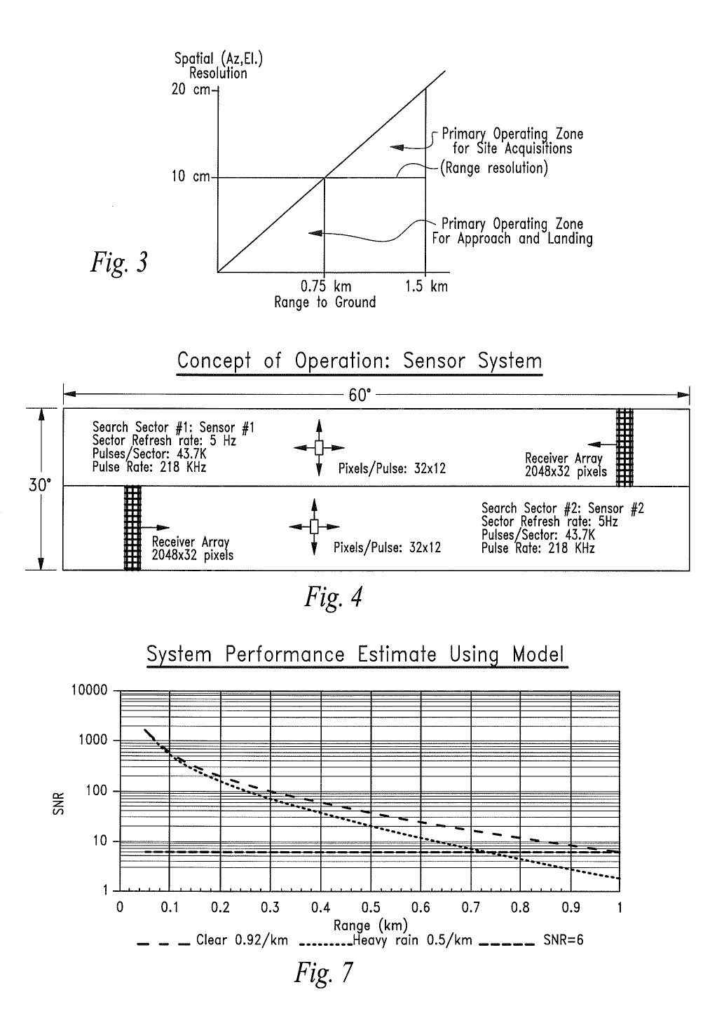

FIG. 3 shows graph illustrating spatial resolution of the sensor system of the invention with respect to range to ground.

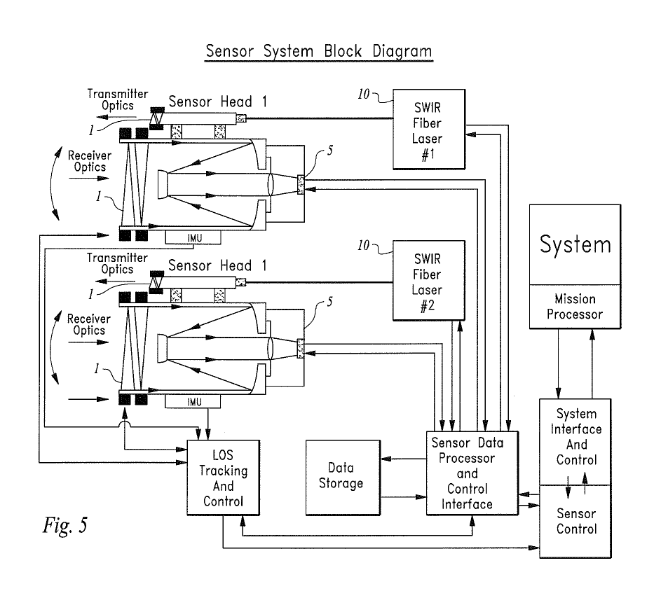

Turning now to FIGS. 4 and 5, the sensor design in a first preferred embodiment of the invention may comprise two beam steering means 1 such as two wide FOV (15°) line scanners using for instance, counter-rotating prisms or Risley prism assemblies, with each surveying a large swath covering about half of the field of regard. In this embodiment, each of two photodetector array/read out integrated circuit modules 5 are provided. The photodetector arrays may comprise focal plane arrays (FPAs) that are responsive to a predetermine range of the electromagnetic spectrum such as a 2,048×32 pixel InGaAs array, responsive to the 1.54 micron wavelength laser.

The line scanners 1 are scanned in azimuth about 60° five times a second. In this preferred embodiment, two 10 cm aperture receiver optics can provide high resolution in 3-D over the intended surveillance volume.

As the two receiver optics are scanned in azimuth, two imaging sources such as lasers 10 that may comprise two SWIR fiber laser assemblies, transmit beams that are directed toward the portion of the surveillance field being observed, which transmitted beams may be scanned using a line scanner means 1 such as counter rotating prisms or Risley prisms.

A relatively short pulse (<2 nanosec) operation of the lasers 10 enables a 10 cm range measurement in each pixel using a LIDAR time-of-flight approach to estimate range. The very high pulse rate (˜200 KHz per laser) enables the required volume search rate.

Elements of a preferred embodiment of the invention are described below:

Two SWIR fiber lasers 10 operate at ˜200 KHz pulse rate and produce ˜50 μJoules of energy per pulse: The output pulses from lasers 10 are used to interrogate a three-dimensional field of regard of 60° in azimuth and 30° in elevation out to a minimum range of 1 km five times a second.

Two 10.0 cm aperture receiver telescopes each with 60° azimuth and 30° elevation fields of regard detect return laser pulses with an instantaneous field-of-view (“IFOV”) of 130 micro-radians (˜10 cm at 0.75 km) and a range uncertainty of ˜10 cm: The resulting high accuracy voxels, updated five times each second, enable rapid, accurate predictions. This tracking accuracy permits autonomous UAS landing.

An advanced 3-D focal plane array/read-out integrated circuit (FPA/ROIC) module 5 for each receiver telescope is provided, each having an array of 2,048×32 photodetector pixel elements. The invention preferably comprises a photodetector pixel element of ˜7.5 micron size. A preferred 3-D focal plane array/read out integrated circuit LIDAR imaging module 5 architecture that uses stacked IC chip technology is disclosed in, for instance, U.S. Pat. No. 7,436,494 entitled “Three-Dimensional LADAR Module With Alignment Reference Insert Circuitry” assigned to Irvine Sensors Corp, assignee of the instant application and issued on Oct. 14, 2008.

It is the high performance and pixel output processing density of the 3-D FPA/ROIC module in this embodiment that increases scene detection at the desired extended range with the small aperture receiver and low pulse energy.

A counter-rotating wedge assembly 1 in cooperation with each of the receiver telescopes and the transmitter telescopes is used to accomplish a rapid azimuth sweep of both the transmitted and received beams: The receiver telescopes' elevation field-of-view is the full 15° for the exemplar system. Each full rotation of the wedges accomplishes two full azimuth scans.

An algorithm suite executed in suitable electronic circuitry such as an FPGA-based processor performs data processing operations to accomplish landing site survey, characterization and selection and then to control the approach and landing sequence.

A preferred embodiment for the UAS laser 10 outputs about 50 μjoules per pulse and has a minimum 218 KHz pulse rate that can be met using a state-of-the-art Perseus Fiber Laser built by Lockheed Martin Aculight.

The top level optical parameter requirements of the preferred embodiment of the sensor system are a 15° elevation field-of-view, a 1° azimuth field-of-view, a IFOV of 130 μrad, comprising an effective collecting area of 10.0 cm, and an interface to a 2,048×32 focal plane array with 7.5 micron detector pitch.

The transmitter optical design (upscope and holographic beam-shaping lens) may use a suitably designed optical system as is known in the optical design arts.

The preferred FPA/ROIC 5 is an InGaAs focal plane array in a preferred 2048×32 format with small pixel pitch.

The 3-D LIDAR system of the invention produces over 150 million pixel samples per second. Algorithmic operations may require up to a 1,000 operations per pixel to derive final navigation system inputs. Three-dimensional stacked micro-electronic technology with available dense interconnect and low-power capabilities are well-suited to the invention and these high performance requirements such as are disclosed to the assignee of the instant application. For example, Irvine Sensors Corporation, assignee of the instant application, has developed several patented techniques for stacking and interconnecting multiple integrated circuits. Some of these techniques are disclosed in U.S. Pat. Nos. 4,525,921; 4,551,629; 4,646,128; 4,706,166; 5,104,820; 5,347,428; 5,432,729; 5,688,721; 5,953,588; 6,117,704; 6,560,109; 6,706,971; 6,717,061; 6,734,370; 6,806,559 and U.S. Pub. No. 2006/0087883.

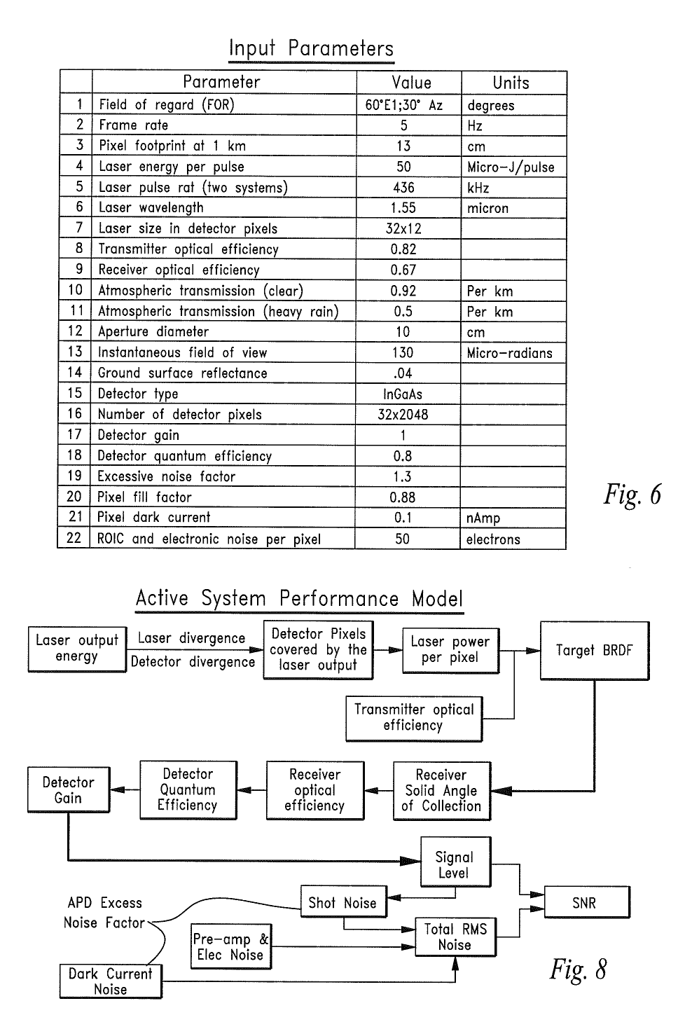

FIG. 6 is a table showing a set of input parameters for a preferred embodiment of the invention.

FIG. 7 is a graph showing estimated system performance using a verified active system performance model.

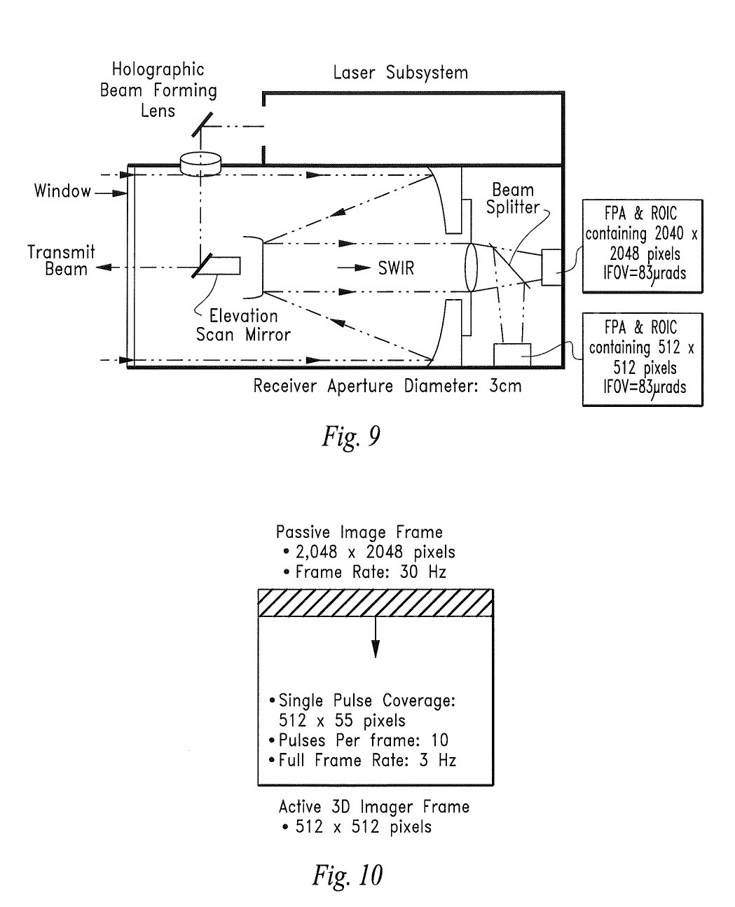

An active sensor system performance model illustrating performance of the invention is illustrated in FIG. 8. The active system model has undergone extensive verification and testing through comparison of field system performance with modeled predicted results.

An alternative embodiment of the UAS LIDAR sensor of the invention is illustrated in FIGS. 9 and 10. A single laser source is transmitted through suitable beam-forming optics to an elevation scanning mirror and scanned across the field of regard. Reflected laser energy from the scene is received through the sensor window and to beam-splitting optics. Two focal plane array/read out integrated circuit assemblies are provided for receiving and processing of the portion of the beam imaged upon them.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A sensor element comprising:
an imaging source having a predetermined wavelength of the electromagnetic spectrum,
imaging source beam steering means comprising a plurality of counter-rotating prisms for imaging a target with the imaging source
a photodetector array responsive to the predetermined wavelength of the imaging source, and,
optical receiving beam steering means comprising a plurality of counter-rotating prisms for receiving and transmitting reflected imaging source energy from the target to the photodetector array.

2. The sensor element of claim 1 wherein the photodetector array comprises a three-dimensional electronic module comprising a stack of integrated circuit chips wherein at least one of the chips comprises a read out integrated circuit.

3. The sensor element of claim 2 wherein the predetermined wavelength of the imaging source is about 1.54 microns.

4. The sensor element of claim 2 wherein the photodetector array comprises an InGaAs focal plan array responsive to the 1.54 micron region of the electromagnetic spectrum.

5. A sensor system comprising a plurality of sensors elements wherein at least two of the sensor elements comprise:
an imaging source having a predetermined wavelength of the electromagnetic spectrum,
imaging source scanning means comprising a plurality of counter-rotating optical prisms for imaging a target with the imaging source,
a photodetector array responsive to the predetermined wavelength of the imaging source, and,
optical receiving means comprising a plurality of counter-rotating optical prisms for receiving and transmitting reflected imaging source energy from the target to the photodetector array.

6. The sensor system of claim 5 wherein the photodetector array comprises a three-dimensional electronic module comprising a stack of integrated circuit chips wherein at least one of the chips comprises a read out integrated circuit.

7. The sensor system of claim 6 wherein the predetermined wavelength of the imaging source is about 1.54 microns.

8. The sensor element of claim 6 wherein the photodetector array comprises an InGaAs focal plan array responsive to the 1.54 micron region of the electromagnetic spectrum.
